(19) United States
(12) Patent Application Publication
(10) Pub. No.: US 2006/0236089 A1
(43) Pub. Date: Oct. 19, 2006

(54) Automatic address-book updating system and method

(76) Inventor: Gal Cohen, Haifa (IL)

Correspondence Address: KATTEN MUCHIN ROSENMAN LLP, 575 MADISON AVENUE, NEW YORK, NY, 10022-2585, US

(21) Appl. No.: 11/113,217

(22) Filed: Apr. 19, 2005

(51) Int. Cl. H04L 9/00

(52) U.S. Cl. 713/150

(57) ABSTRACT

The present invention is a system and method for ensuring the validity of the personal contact information in a personal database. The invention provides means for receiving automatic updates of changes in the existing records of the personal contact information database without having to expose the data to security breaches by storing it in a central database. The system can independently recognize cross references in different clients' databases and automatically perform updates whenever changes in the personal data occur. For each registered user the system holds data that is derived from their personal database on a central server. But the system does not hold the data itself; it holds several digest values, hash functions of a subset of a record's fields, for each record. The system can then compare the digest values of different clients, find cross references between users and perform updates when necessary.

### BACKGROUND

The present invention relates in general to systems and methods for updating contact data in personal address-books, and more specifically to systems and methods for automatic updating contact data in personal address-books without saving any sensitive data in the system, not exposing such data via communication.

Keeping an updated contact data in a personal address-book is becoming crucial in recent years, as people tend to change their contact information (such as mobile phone number or email address) quite frequently.

Known in the art are several methods for ensuring the validity of central contact lists and efficiently updating list owners of any change. U.S. Pat. No. 6,073,141, for instance discloses a system for providing a current set of records to a plurality of users. The system includes a master database, which stores a master set of a plurality of records, and a plurality of terminals in communication with the master database. Each of the terminals stores a subset of the master set of records. The system provides a mechanism that indicates which records have been updated since a predetermined period of time. This solution is aim at turning the updating process of such a system more efficient. But this system is suitable only for organizations were all users share the contact information with a central database.

There is therefore a need for a means for maintaining an updated personal address-book, which may be useful for organizations as well as individuals and which, for security reasons, does not relay on storing the sensitive information anywhere outside the personal address-books, either exposed or encrypted.

### SUMMARY

The present invention discloses a data management method and system, enabling to update contact lists stored in personal local address-books, through a communication network, without exposing any sensitive data outside the personal address-books. The contact list entries are stored only at the personal local address-books of the users.

The system includes the following modules: a user-registration module; an association module for matching-up pairs of users (“buddies”), based on mutual similarities between users' digest-value; a module for notifying and updating local address-books, through a peer-to-peer connection, or through a temporary encrypted cache in the system.

The method includes the following steps: users' registration; identifying associations between registered users, based on mutual similarities of hashed user-data; identifying and notifying of personal details changes through a communication network; initiating a temporary direct communication between the associated users, and transferring updated personal data between associated users, in a secure way.

The associations between the users are determined automatically by finding ‘good-enough’ matches of digest values of pairs of registered users, wherein the digest values represent (but do not reveal) the personal information of the users and are stored in the system.

The abovementioned association process does not involve the users themselves: they keep updating their contacts normally, by adding, deleting and changing entries in their personal address-books.

The digest values are calculated as one-way hash functions of combination of records, taken from the personal address-books.

For updating the users, the system tries to establish a direct communication channel (a peer-to-peer connection) or, in case such a direct channel cannot be established, uses an entry in the system's database as a temporary cache, encrypted for recipients' eyes.

### BRIEF DESCRIPTION OF THE DRAWINGS

These and further features and advantages of the invention will become more clearly understood in the light of the ensuing description of a preferred embodiment thereof, given by way of example, with reference to the accompanying drawings, wherein

FIG. 1 illustrates the first step of the user registration process, according to an embodiment of the present invention;

FIG. 2 illustrates the second step of the user registration process;

FIG. 3 illustrates the automatic ‘buddy-association’ process, according to an embodiment of the present invention;

FIG. 4 illustrates the two possible updating procedures, according to the present invention.

### DETAILED DESCRIPTION OF THE PERFERRED EMBODIMENT

The present invention is a new efficient and secure system and method for ensuring the validity of contact information in personal address-books. The invention provides means for automatically updating existing records, without exposing any sensitive data outside the users' personal address-books (either bare or encrypted).

For each registered user the system holds data that is derived from their personal information. It also holds similar data, derived from each contact record in the user's address-book. The system does not hold the data itself; instead, it holds digest values for each record, whereas the digest values are hash functions of subsets of records' fields.

For each record in the user's address-book, including the user's personal information, the client software creates several such digest values, each comprised of selected fields. If, for instance, a record contains fields such as name, home phone, cellular phone and email address, several digest values may be created, combining different subsets of the fields, and one which includes them all.

Each such digest-value is a result of a unidirectional hash function, which reflects the data structure of the original information. These values are stored in the system's database, but the original data cannot be deduced from them. The security of the information held by the system is, therefore, not at risk.

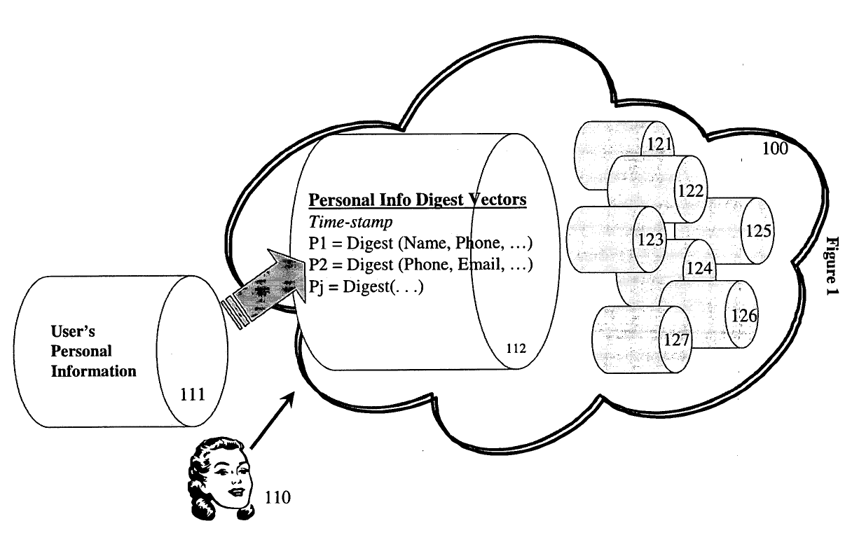

FIG. 1 illustrates the first step of the registration procedure, according to the preferred embodiment of the present invention: As user 110 initiates the registration procedure, the system 100 gives user 110 a user ID number and allocates a database region. The client-software (at the user's end) then calculates several digest values of the user's personal information, and saves those values (112) in the system (100) with a time-stamp of the operation.

The digest values are composed of a predetermined subset of fields; therefore each digest value represents the same subset of fields for all users. This means that the first digest value (P1) is calculated for the same subset for all users (for example, name, home-phone and zip code), the second (P2) for another subset, and so forth.

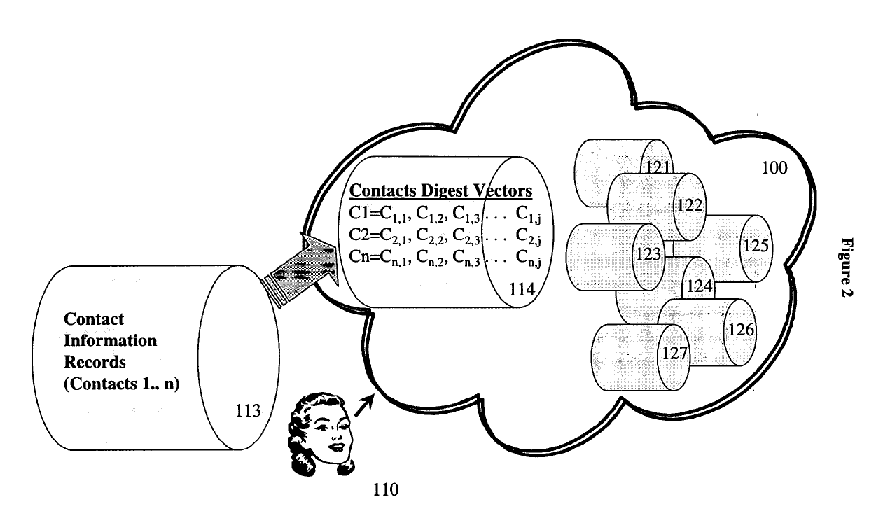

At the second stage of registration, which is illustrated in FIG. 2, the system calculates, at the user's end, the same digests for each contact in the user's address-book (113) and stores those values in system (100) as contact digest vectors (114). It is important to note that the time-stamp is not required here, since the system does not need to keep track of the history of changes made in the user's list of contacts.

Before creating the digest values, the system executes a normalization procedure on all information. This procedure ensures that all fields are represented in a uniform manner for all users, and eliminates unnecessary variations of the same data. Normalizing the information includes, for instance, adding the country code and area code to each phone number and ensuring that the name are capitalized in a uniform manner. It may also include a transcription of names to a unified language.

Whenever the personal information of a user changes (for example, a user changes his or her phone number), the system creates new digest values for the user's personal information and marks them with the timestamp of the change. The system adds the new digest records to the list of the user's personal information digest-values and does not delete the records of the old personal information. This is to leave trails on users' past data, which may then be used in the buddy-association process described below. In contrast, as mentioned above, whenever users change records in their contact information, the system creates new digest values for those records and replaces the old ones.

The use of those digest values enables the system to compare them, in order to find other users in the system as a whole, which contain several equal digests of the same subsets. This attribute is used in the automatic buddy-association process. In one embodiment of the present invention, the system periodically operates the buddy-association process. This process searches for similarities between the current and historical user information digest values and the contact information data of other users.

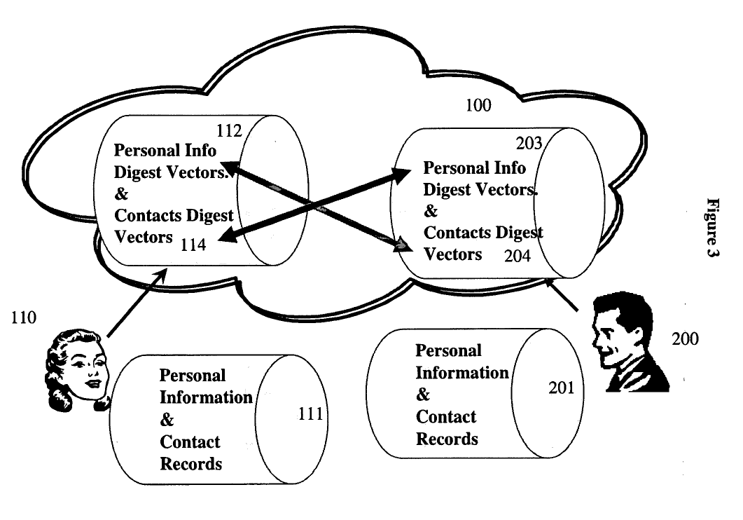

This process is illustrated in FIG. 3: if the system 100 identifies that a combination of digest values of the personal information 112 of user 110 matches a combination of digest values of a record in the contact information 204 of user 200, and also that a certain combination of the digest values of the personal information 203 of user 200 matches a combination of digest values of a record in the contact information 114 of user 110, the system 100 registers the users 110 and 200 as ‘buddies’. From that point on, whenever either user 110 or 200 perform any changes in their personal information, the other user's record is automatically updated, according to a procedure which is described below.

Whenever system 100 searches for matches between a user's personal information and other users' contact information, it includes in the search all of the user's personal information digest values, including the historical ones that are stored in the system. This enables the system to find ‘buddies’ even if users do not hold up-to-date information of other users.

It is important to note that whenever the system finds a unilateral match between two users (if, for instance, user 200 has the contact information of user 110, but user 110 does not have the details of user 200 in her address-book) it does not define users 110 and 200 as ‘buddies’. In addition to preventing users from having their information updates to be traced by unauthorized persons, who somehow obtained their personal information, this also drastically reduces the probability of false positive mistakes.

The digest-values comparison is based on a ‘good-enough’ match, whereas not all values must be identical but, if a sufficient amount of them do match, the system can assume that the differences stem from minor variations in the same record, such as in the middle name of a person or in the absents of information in one of the fields. The fact that the system holds several digest values, which are comprised of different subsets of fields for each record, increases the probability of finding matches, since it is common for people to hold partial information of their contacts in their address-books.

The automatic buddy-association process according to digest value matching might potentially produce two kinds of false results: a false positive and a false negative. When a false positive occurs, the system mistakenly decides that two different records are similar. A false negative occurs when the system does not associate two potential ‘buddies’.

Provided that the matching algorithm is tuned correctly, given the bidirectional matching requirement, the statistical probability for false-positives is very low, as mentioned above. In such cases, the client application at the user's end would automatically reject the incorrect association at the updating stage, and notify the system about the mismatch.

False negatives usually occur when one has a confusing record of a contact (such as name misspell or wrong phone number). In this case, if they are truly ‘buddies’ in the real world, at some future point the user will correct the inaccurate data and the system would be able to create the association between them.

As a general tendency, the system's algorithm is inclined towards increasing the likelihood of producing false negative errors in order to eliminate the possibility of false positive ones, since false-positives might expose user's personal information and false-negatives are usually corrected in the ‘real world’, as explained above.

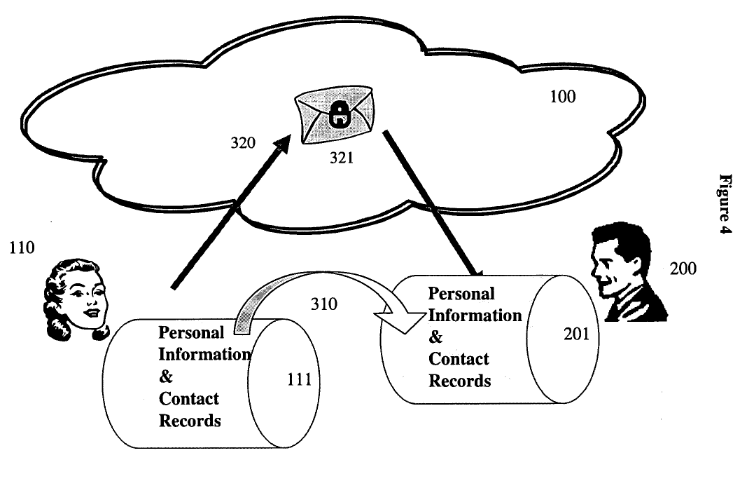

Following is a description of the updating procedure as it is illustrated in FIG. 4: Provided that user 110 and user 200 were identified as ‘buddies’, when the personal details of user 110 change, the system initiates an updating procedure in order to update the record in local address-book 201 of user 200. When the system identifies that both user 110 and user 200 are simultaneously online, it instructs both of them to open a temporary direct connection 310 (a peer-to-peer connection), between the two users, and the updated data is then transferred from user 110 to user 200. In order to increase security, this data is encrypted for the eyes of users 200 only (by using a public-key encryption or another encryption mechanism).

If, after a predetermined time, such as a couple of days, the system does not succeed in transferring the data in this manner, a second transferring method 320 is applied: The system then asks user 110 to send the relevant data to the system 100, encrypted in a manner which ensures that only user 200 may decrypt it. Next, as user 200 connects, he is notified about the encrypted data 321 that is then downloaded to his local machine, decrypted and inserted into the local address-book 201. The encrypted data 321 is then erased from the system 100. The system allows users to define that only some of the records in their local address-book are to be integrated into the system. Provided that most personal information managers (PIMs) allow users to classify their records into several categories (e.g. “Business”, “Friends”, “Family”, “Professional” etc.) users may instruct the system to relate only to certain categories and to ignore the rest. In addition, a user might instruct the system to only track some of his fields (such as email and phone-numbers), while other fields remain untracked (home-address, for example).

While the above description contains many specificities, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. A data management method enabling to update contact lists stored in personal local address-books, through a communication network, wherein the contact lists' information records are stored only at personal local address-books of the users, said method comprising the steps of:
identifying association between registered users, based on mutual similarities between calculated values of unidirectional hash function of user records;
receiving from users messages notifying of personal details change through communication network;
initiating a temporary direct communication channel between the associated users; and
transferring personal updated personal data between the associated users through the direct communication channel, or an encrypted temporary cache;

2. The method of claim 1 wherein the relations between the users are updated by the users themselves.

3. The method of claim 1 wherein the unidirectional hash function is a digest code, which is stored in a the system's database.

4. The method of claim 1 further comprising the steps of: enabling temporary encrypted indirect update data transaction between associated users if initiation of direct communication channel between the users has failed.

5. The method of claim 3 wherein digest code is a nonrandom nonreversible hash function of at least one combination of records of the personal local address-book, including historical non-updated records.

6. The method of claim 1 wherein the communication network is a wireless network.

7. The method of claim 1 wherein the communication network is a wired network.

8. The method of claim 4 wherein the direct communication channel is a peer to peer connection.

9. The method of claim 1 further comprising the step of normalizing the personal information records according to uniform format.

10. A data management application enabling to update contact list stored in personal local address-books between users through a communication network, wherein the contact list information records are stored only at personal local address-books storage devices of the users, said application comprising the following modules:
association module for finding correlation between registered users based on mutual similarities between calculated values of unidirectional hash function of subsets of users records;
management module updating local personal databases by receiving messages notifying of personal details change through communication network and transferring personal updated personal data between associated users through a temporary direct communication channel.

11. The application of claim 10 wherein the relations between the users are updated by the users themselves.

12. The application of claim 10 wherein unidirectional hash function is a digest code, which is stored in a the system's database.

13. The application of claim 10 wherein the data transfer between associated users is processed by temporary encrypted indirect update data transaction between associated users if initiation of temporary direct communication channel between the users has failed.

14. The application of claim 12 wherein digest code is a nonrandom nonreversible hash calculation of at least one combination of records of the personal local address-books, including historical non-updated records.

15. The method of claim 10 wherein the communication network is a wireless network.

16. The application of claim 10, wherein the communication network is a wired network.

17. The application of claim 10, wherein the direct communication channel is a peer to peer connection.

18. The application of claim 10 wherein the personal information records normalized according to uniform format.
